(19) United States
(12) Patent Application Publication
(10) Pub. No.: US 2007/0147268 A1
(43) Pub. Date: Jun. 28, 2007

(54) Distributing overall control of mesh AMR LAN networks to WAN interconnected collectors

(75) Inventors: Raymond H. Kelley, Raleigh, NC (US); Dileep Rudran, Cary, NC (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Elster Electricity, LLC, Raleigh, NC (US)

(21) Appl. No.: 11/317,870

(22) Filed: Dec. 23, 2005

(51) Int. Cl. H04L 12/28; H04L 12/16; H04L 12/66

(52) U.S. Cl. 370/254; 370/352; 370/260

(57) ABSTRACT

Collectors within a wireless metering network that control a wireless Local Area Network (LAN) of nodes. The collectors typically interact over a WAN with a head-end system, which has network management and control of all collector LANs. Control is distributed from the head-end system down to the data collectors by using TCP/IP data networks to interconnect the data collectors. The data collectors are interconnected on high bandwidth TCP/IP networks and can establish peer-to-peer communications and participate in the overall network control. The data collectors coordinate information about the mesh LAN-connected nodes with one another in a peer-to-peer manner to distribute overall network control to establish peer-to-peer registration of data collectors during self installations, and optimize overall self-healing and adaptive reconfiguration capabilities of the network when nodes migrate such that data collection processes can proceed without interruption.

### FIELD OF THE INVENTION

The present invention relates to metering systems, and more particularly, to wireless networks for gathering metering data.

### BACKGROUND OF THE INVENTION

Automated systems for collecting meter data use a fixed wireless network, that includes, for example, repeaters and gateways that are permanently affixed on rooftops and poletops and strategically positioned to receive data from enhanced meters fitted with radio-transmitters. Typically, these transmitters operate in the 902-928 MHz range and employ Frequency Hopping Spread Spectrum (FHSS) technology to spread the transmitted energy over a large portion of the available bandwidth. Data is transmitted from the meters to the repeaters and gateways and ultimately communicated to a central location.

These systems may be configured having a mesh network wireless system wherein a data collector is responsible for synchronizing, configuring, managing, and collecting data from a Local Area Network (LAN) of wireless devices for electric, gas, and water meters. While these data collectors control and manage their LAN network of devices, they do have any knowledge about their peers, i.e., the other data collectors, that make-up the system deployment. A typical system deployment requires multiple data collectors to work in conjunction with a controlling head-end system.

In conventional systems, while data collectors manage their individual local area networks, the head-end is the primary point of control across data collectors, because it is the point at which other external systems (i.e., CIS, billing, load research, etc.) or external users interact with the system. Given, the need for the system to keep track of relatively up-to-date information about the state of the network and the limitations (such as speed and bandwidth) of existing communication technologies that restrict practical application of peer to peer communication and coordination between data collectors, the network has to operate as a “controlled” mesh, i.e., nodes have to wait some configurable period after loss of communications before looking for alternate paths. During this period, there is essentially no way to communicate to the node. If the node is a repeater, the nodes for which it is repeating will also lose communication.

Further, in conventional “controlled-mesh” based systems, when a node migrates from one collector to another, it may not be able to unregister from the old collector due to communication problems. Even though call-in notifications from the collectors to the host are provided, they are often not used to notify the host of node migrations. In these cases, the host will only discover the migrated node during a later scheduled communication session with the new collector to which the node has migrated. Thus, if the host reads the old collector for a migrated node, it will find the node is still registered, as well as data for that node. This data may be old or invalid, and based on this, the host cannot conclude if the node has migrated. Even if the host could deduce that the node had migrated, the host would have no knowledge of the new collector to which the node has migrated, until it performed a read of the new collector. Thus, the host either calls all collectors in the system to try to discover the new node or waits until it reads the new collector as part of a scheduled communication session to discover the migrated node.

Thus, while existing fixed wireless systems have automated the daily collection of meter data, such systems place a substantial burden on the head-end system to maintain the system configuration. Therefore, it would be desirable if the wireless system could leverage ad-hoc wireless technologies to simplify the maintenance of such systems.

### SUMMARY OF THE INVENTION

Collectors within a wireless metering network control and manage a wireless Local Area Network (LAN) of nodes. The collectors typically interact over a WAN with a head-end system, which has network management and control of all collector LANs. This invention presents a system where overall network control is distributed from the head-end system to the WAN connected data collectors. By using traditional WANs, TCP/IP capable wide area networks (WAN) and/or metropolitan area networks (MAN) data networks, data collectors for mesh LAN networks can be interconnected. With the data collectors interconnected on high bandwidth TCP/IP networks they can more readily establish peer-to-peer communications and rapidly participate in the overall network control and management. In particular, the data collectors are able to coordinate information about the mesh LAN-connected nodes with one another in a peer-to-peer manner to distribute overall network control, to establish peer-to-peer registration of data collectors during self installations, and to optimize overall self-healing and adaptive reconfiguration capabilities of the network. This enables rapid self-healing of the overall mesh network when nodes migrate such that data collection processes can proceed without interruption.

In addition, the metering network can take advantage of the higher bandwidth peer-to-peer communications between collectors and operate as either a fully dynamic mesh or a controlled mesh with reduced self-healing latencies. Overall network coordination distributed to the data collectors, allows the head-end system to determine the actual collector to which a LAN node is registered to on a real-time or as needed basis, rather than during the next communication session with the data collectors.

The present invention distributes the overall network management to provide self-adaptation and removes dependence upon a centralized head-end system to reconfigure the network after a node migration. Additional features and advantages of the invention will be made apparent from the following detailed description of illustrative embodiments that proceeds with reference to the accompanying drawings.

### BRIEF DESCRIPTION OF THE DRAWINGS

Other features of systems and methods for gathering metering data are further apparent from the following detailed description of exemplary embodiments taken in conjunction with the accompanying drawings, of which:

FIG. 1 is a diagram of a wireless system for collecting meter data wherein collectors are in peer-to-peer communication;

FIG. 2 is a diagram of a wireless system that provides for self-installation and registration of collectors;

FIG. 3 is a diagram of steady-state addressing of collectors in the wireless system of FIG. 2; and

FIG. 4 is a diagram of coordination of collectors to provide node self-healing across LAN(s) in the wireless system of FIG. 2.

### DETAILED DESCRIPTION OF ILLUSTRATIVE EMBODIMENTS

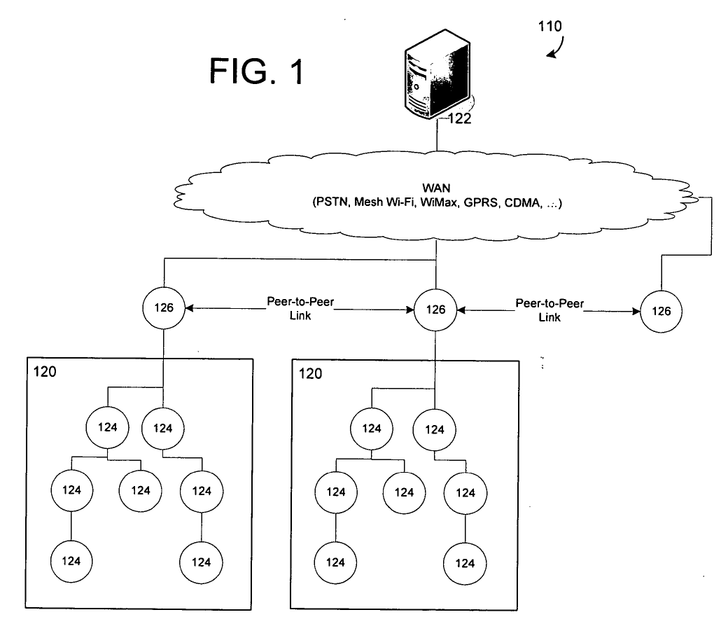

Exemplary systems and methods for gathering meter data are described below with reference to FIGS. 1-4. It will be appreciated by those of ordinary skill in the art that the description given herein with respect to those figures is for exemplary purposes only and is not intended in any way to limit the scope of potential embodiments.

Generally, a plurality of meter devices, which operate to track usage of a service or commodity such as, for example, electricity, water, and gas, are operable to wirelessly communicate with each other. A collector is operable to automatically identify and register meters for communication with the collector. When a meter is installed, the meter becomes registered with the collector that can provide a communication path to the meter. The collectors receive and compile metering data from a plurality of meter devices via wireless communications. A communications server communicates with the collectors to retrieve the compiled meter data.

FIG. 1 provides a diagram of an exemplary metering system 110. System 110 comprises a plurality of meters 124, which are operable to sense and record usage of a service or commodity such as, for example, electricity, water, or gas. Meters 124 may be located at customer premises such as, for example, a home or place of business. Meters 124 comprise an antenna and are operable to transmit data, including service usage data, wirelessly. Meters 124 may be further operable to receive data wirelessly as well. In an illustrative embodiment, meters 124 may be, for example, a electrical meters manufactured by Elster Electricity, LLC.

System 110 further comprises collectors 126, which are also meters operable to detect and record usage of a service or commodity such as, for example, electricity, water, or gas. Collectors 126 comprise an antenna and are operable to send and receive data wirelessly. In particular, collectors 126 are operable to send data to and receive data from meters 124. In an illustrative embodiment, meters 124 may be, for example, an electrical meter manufactured by Elster Electricity, LLC.

A collector 126 and the meters 124 for which it is configured to receive meter data define a subnet or LAN 120 within system 110. For each subnet/LAN 120, data is collected at collector 126 and periodically transmitted to a communication/head-end server 122. The communication/head-end server 122 stores the data for analysis and preparation of bills. The communication/head-end server 122 may be a specially programmed general purpose computing system and may communicate with collectors 126 wirelessly or via a wire line connection such as, for example, a dial-up telephone connection or fixed wire network. By example, the communication from the collector 126 to the server 122 could be via any available communication link, such as a public network (PSTN), a Wi-Fi network (IEEE 802.11), a WiMax network (IEEE 802.16), a combination WiMax to Wi-Fi network, WAN, TCP/IP wireless network, etc. Further, communication between collectors 126 and the server 122 is two-way where either may originate commands and/or data.

Thus, each subnet/LAN 120 comprises a collector 126 and one or more meters 124, which may be referred to as nodes of the subnet. Typically, collector 126 directly communicates with only a subset of the plurality of meters 124 in the particular subnet. Meters 124 with which collector 126 directly communicates may be referred to as level one meters. The level one meters are said to be one “hop” from the collector 126. Communications between collector 126 and meters 124 other than level one meters are relayed through the level one meters. Thus, the level one meters operate as repeaters for communications between collector 126 and meters 124 located further away in subnet 120.

Each level one meter directly communicates with only a subset of the remaining meters 124 in the subnet 120. The meters 124 with which the level one meters directly communicate may be referred to as level two meters 124b. Level two meters are one “hop” from level one meters, and therefore two “hops” from collector 126. Level two meters operate as repeaters for communications between the level one meters and meters 124 located further away from collector 126 in the subnet 120.

A subnet 120 may comprise any number of levels of meters 124. For example, a subnet 120 may comprise one level of meters but might also comprise eight or more levels of meters 124. In an embodiment wherein a subnet comprises eight levels of meters 124, as many as 1000 or more meters might be registered with a single collector 126.

Each meter 124 and collector 126 that is installed in the system 110 has a unique identifier stored thereon that uniquely identifies the device from all other devices in the system 110. Additionally, meters 124 operating in a subnet 120 comprise information including the following: data identifying the collector with which the meter is registered; the level in the subnet at which the meter is located; the repeater meter with which the meter communicates to send and receive data to the collector; an identifier indicating whether the meter is a repeater for other nodes in the subnet; and if the meter operates as a repeater, the identifier that uniquely identifies the repeater within the particular subnet, and the number of meters for which it is a repeater. Collectors 126 have stored thereon all of this same data for all meters 124 that are registered therewith. Thus, collector 126 comprises data identifying all nodes registered therewith as well as data identifying the registered path by which data is communicated with each node.

For most network tasks such as, for example, reading data, collector 126 communicates with meters 124 in the subnet 120 using point-to-point transmissions. For example, a message or instruction from collector 126 is routed through a defined set of meter hops to the desired meter 124. Similarly, a meter 124 communicates with collector 126 through the same set of meter hops, but in reverse.

In some instances, however, collector 126 needs to quickly communicate information to all meters 124 located in its subnet 120. Accordingly, collector 126 may issue a broadcast message that is meant to reach all nodes in the subnet 120. The broadcast message may be referred to as a “flood broadcast message.” A flood broadcast originates at collector 126 and propagates through the entire subnet 120 one level at a time. For example, collector 126 may transmit a flood broadcast to all first level meters. The first level meters that receive the message pick a random time slot and retransmit the broadcast message to second level meters. Any second level meter can accept the broadcast, thereby providing better coverage from the collector out to the end point meters. This process continues out until the end nodes of the subnet. Thus, a broadcast message gradually propagates out the subnet 120.

Referring again to FIG. 1, within the subnets 120, meters 124 and a collector 126 may communicate to each other via any one of several robust wireless techniques such as, for example, frequency hopping spread spectrum (FHSS) and direct sequence spread spectrum (DSSS). In addition, they may communicate using a Wi-Fi (Wireless Fidelity) wireless network. Wi-Fi networks use radio technologies defined by various IEEE 802.11 standards and allow devices to connect to the Internet and other networks to send and receive data anywhere within the range of a base station. A particular advantage of using a Wi-Fi network is that it is an inexpensive and practical way to share a network connection. Extensions of the Wi-Fi protocol allow the Wi-Fi radios to operate in mesh networks such that meters may communicate with other meters without the requirement of direct connection with a base station. Communication with the communication server 122 can be accomplished using any available communications ink.

Within the subnets 120, the meters 124 and collector 126 may communicate to each other via a WiMax wireless network. WiMax networks use radio technologies defined by various IEEE 802.16 standards and allow devices to connect to the Internet and other networks to send and receive data anywhere within the range of a base station. The WiMax protocol standard includes a mesh networking capability so meters can communicate with each other as well as with a base station. Here again, communication with the communication server 122 can be accomplished via any available communications link.

To provide network services to coordinate all of the collectors 126 across the system deployment, LANs could be subdivided into different segments typically labeled as: operating territories, regions, districts, or other groups. These groups are assumed to be the population of collectors 126 that need to all have the same provisioning from the host 122 (e.g., TOU configuration based upon regulatory agencies, time zones, or other) to support node migration between data collectors 126. In this hierarchical model, the head-end 122 has the overall responsibility of managing and coordinating all of the collectors 126 across the system 110 and all operating territories in terms of time synchronization, device configurations, data collection configurations.

The present invention includes techniques that enable the collectors 126 with peer-to-peer communication, as shown in FIG. 1, to coordinate the overall network control without as much reliance upon the host system 110. Peer-to-peer communication between the collectors 126 becomes more viable in terms of “always on” connections that support more real-time communication possibilities. With IP WAN and/or MAN networks (e.g., Mesh Wi-Fi, WiMAX, GPRS, CDMA, etc.) interconnecting the collectors 126, overall network control can be distributed from the head end 122 down into the network collectors 126 to further expand the network management capabilities of self installation, self-healing, and self-configuring.

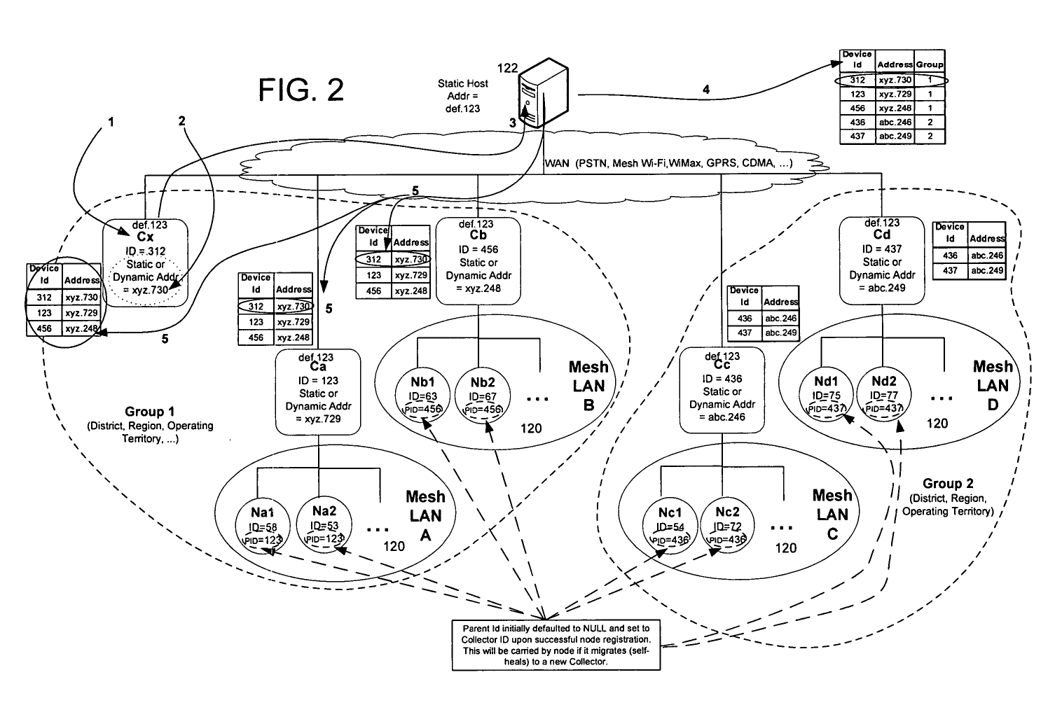

FIGS. 2-4 illustrate self-installation and registration of collectors, and coordination nodes. Certain information may be preconfigured in the collector/node at the time of manufacture, in the field or at the metering ship. Other information provided to the collector/node as it self-installs. As shown in each of the Figs., an address of the host 122, a device ID and a static address may be preconfigured, whereas a dynamic address may be provided to the device during self-installation. Each of these will be described below.

FIG. 2 illustrates self-installation of collectors and registration with system 110. Collectors 126 (shown as Ca, Cb, Cc, Cd . . . Cx) discover peers and their communication addresses during self-installation with the host 122, from the network provider's domain name service, or from another name service that is known to the collectors and which they can update and query. The self-install process begins when a collector (e.g., Cx) is pre-configured with the address of the host 122, its device ID and static address (or NULL for address if dynamic addressing is used) (step 1). The collector Cx is then installed and retrieves and updates its address from the network if previously configured as NULL (step 2). The collector Cx then registers its retrieved/assigned network address and configured device_id with the host 122 (step 3). The host 122 will optionally assign the collector Cx to a group (Group 1) that may designate a grouping such as a district, region, operating territory, etc. The collector will then update a table/database containing the master address-to-device mapping for the system 110 (step 4).

The host 122 may then provide the entire mapping table for Group 1 to all collectors in Group 1, or the host 122 may add only the new mapping to all existing collectors in Group 1. Alternatively, the host 122 may provide a device name in each collector's mapping table that may be used by the collector to lookup the network provider's DNS or other name service (step 5).

Each meter 124 that registers to that collector has its parent identifier set to the device identifier for the collector 126. In this example, meters that register with Cx will have parent identifier set to 312.

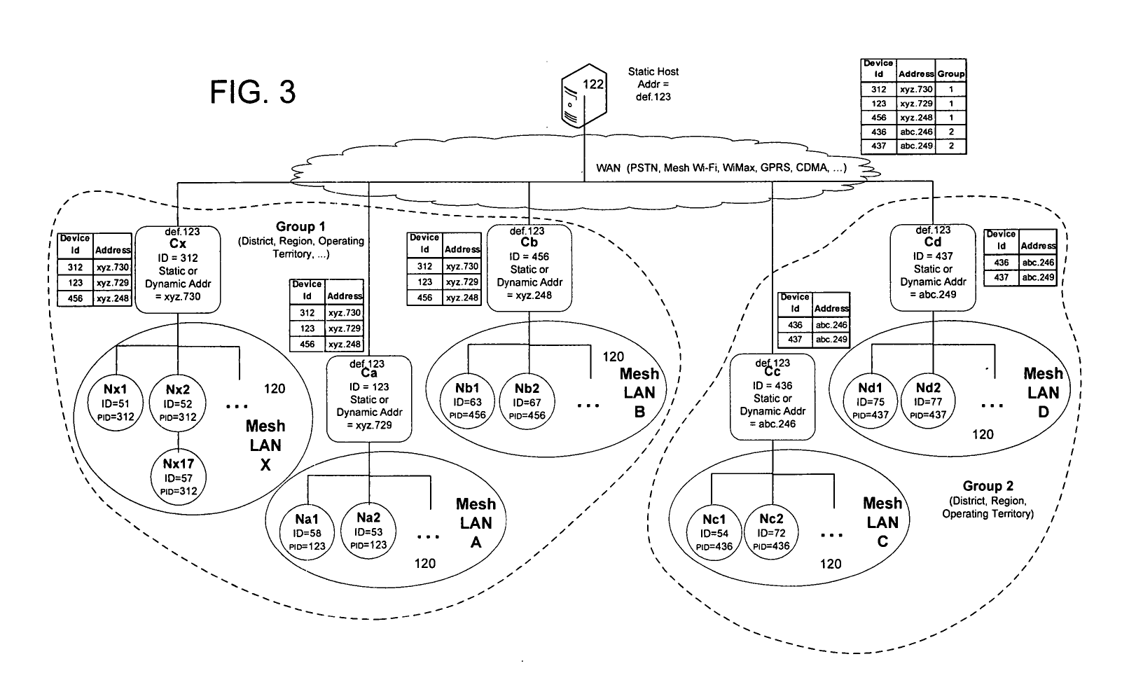

FIG. 3 illustrates a network configuration where peer-to-peer communication between collectors within operating territories is controlled or limited via a grouping mechanism(s) through configurable host provisioning of addresses. A collector in one region or operating territory has mapping tables for only those collectors that belong to the same operating territory/region. This aids in coordinating self installation capability across data collectors within an Operating Territories or other grouping mechanisms throughout the overall network. It also can enable control over meters 124 that belong to collectors in other operating territories from switching across operating territory or grouping boundaries if desired.

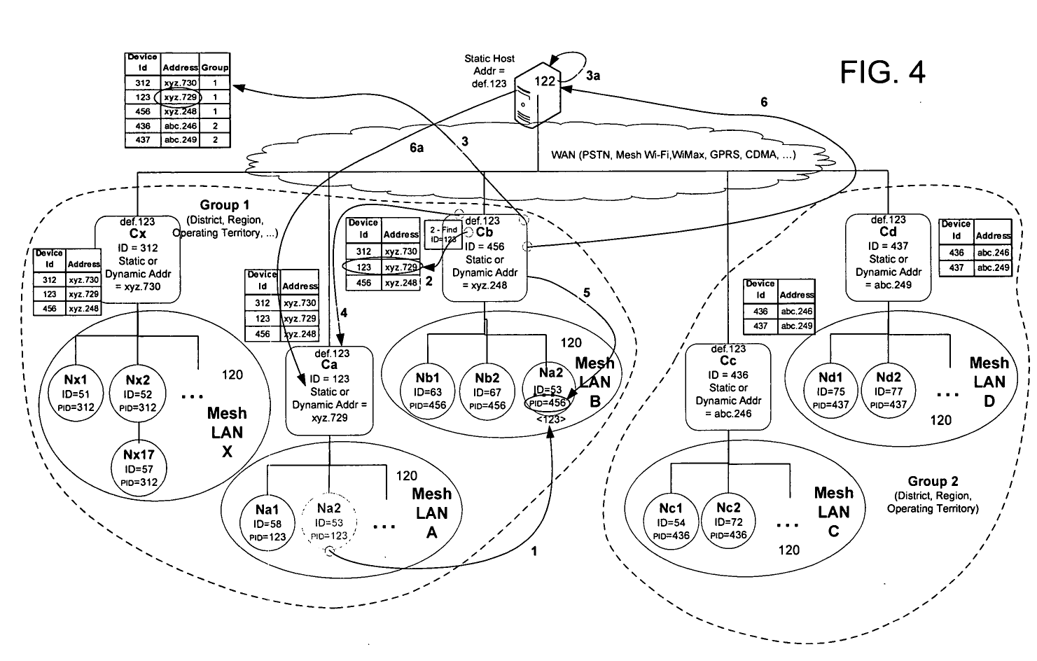

As noted above, in conventional systems when a node migrates it may not unregister from the old collector. FIG. 4 illustrates the coordination of migrating nodes and self-healing across independent LANs 120 where known data collection configurations (i.e., collect LP, billing IDs for arming demand meters, etc.) are passed between the collectors when nodes 124 (shown as Nx, Na, etc.) migrate from one collector to another within a single operating territory. The exemplary coordination illustrated advantageously provides for a system of notifying the host 122 that a node has migrated by allowing the collectors to coordinate registration/unregistration of nodes. The next time a host 122 reads the collector from which a node has migrated, the host 122 will be informed that the node has been unregistered and will be provided with the address for the new collector where the node can be found.

The exemplary processes performed to accomplish above, generally pass state information from the old collector to the new collector when migration occurs (i.e., armed for demand reset) and nodes are unregistered from the old data collector following migration. The processes begin at (step 11) when a node Na2 changes from collector Ca to collector Cb within the same operating territory (e.g., Group 1). Node Na2 carries with it the parent node ID for collector Ca (PID=123). Next, the collector Cb locates the parent device ID of the node Na2 (123) in its mapping table (step 12). At step 13, if the parent ID for node Na2 is not found in the mapping table of collector Cb and the parent id of Na2 is not Null, which implies a new installation, then a request is made by collector Cb for the parent address from the host 122 using Na2 node ID=53. If the host determines that collector Cb and the previous parent of node Na2 are not within the same group (step 13a), then the host 122 will add the Node ID to an exception report for nodes that have jumped groups (i.e. service territory) boundaries. Such nodes may require processing (e.g., downloading new TOU schedules) or forced unregistration (step 13a). If the previous parent of node Na2 is within the same group as collector Cb, then the host will update all collector mapping tables within the group to insure proper synchronization.

At (step 14), the collector Cb will update is mapping table if required and then uses the address of the old collector Ca to read the metered data, status, events, demand reset armed status, billing ID, LP enabled flag, TOU ID, critical tier status, etc. The new collector will also leave its own address as a forwarding address for the migrated node Na2. At (step 15), the collector Cb updates the node Na2 with parent ID 456 (i.e., the ID of collector Cb). At (step 16), the host 122 is notified of the migrated node Na2. If the host 122 attempts to communicate with node Na2 at (step 16a) prior to the notification provided in step (step 16), then the host will discover that the node Na2 is unregistered from collector Ca and has migrated to forwarding address of collector Cb.

The implementation of FIG. 4 reduces the “controlled” aspect of the mesh, which allows the network to operate either as a controlled mesh (i.e., where nodes migrate only if communications to the collector are lost for a certain period of time) or a fully dynamic mesh (i.e., where nodes can migrate as soon as decision logic provides for communications are lost). In addition, the system 110 is able to discover the new location of a node as needed (i.e., without the communication dead time) when it migrates from one collector to another using the additional technique provided when the new collector unregisters the migrated node from the old collector and provides a forwarding address for the migrated node at the old collector.

In addition to the above, the present invention advantageously provides for consolidating data collected into the new collector for easier retrieval by headend system, clean up of data left by nodes that have migrated away from a data collector, coordinating across utility service regions that span regulatory boundaries through operating territories to group together and optimize time-of-use tariff structures, and improving self-healing time across network when collectors fail (i.e., when collectors within operating territory detect a peer has died, then they can initiate a registration process to pick up abandoned nodes).

While systems and methods have been described and illustrated with reference to specific embodiments, those skilled in the art will recognize that modification and variations may be made without departing from the principles described above and set forth in the following claims. Accordingly, reference should be made to the following claims as describing the scope of disclosed embodiments.

What is claimed:

1. A method for self-installing and registering a device with a host system, comprising:
pre-configuring said device with a host address and a device address;
registering with said host and providing said host with said device address;
updating a mapping table to include said device address; and
providing said device address to other devices in communication with said host system.

2. The method of claim 1, further comprising dynamically assigning said device address.

3. The method of claim 2, further comprising:
receiving said device address from said host system; and
storing said host address in a device mapping table stored within said device.

4. The method of claim 1, further comprising updating downstream node from said device with a device identifier of said device.

5. The method of claim 1, providing said device address to other devices further comprising providing said mapping table to all devices within a predetermined group of devices.

6. The method of claim 1, providing said device address to other devices further comprising:
providing a name of said device to all devices within a predetermined group of devices; and
looking-up said device address using said name of said device.

7. A method of coordinating the migration of a node across a network, comprising:
updating a mapping table to include an identifier of said node after said node has migrated from a first communication device to a second communication device;
using an address of said first communication device to determine information about said node;
leaving a forwarding address of said second communication device at said first communication device;
updating said node with an address of said second communication device; and
notifying a host system that said node has migrated.

8. The method of claim 7, further comprising:
determining if an identifier of said first communication device is in said mapping table; and
if not, requesting said identifier of said first communication device from said host.

9. The method of claim 7, further comprising adding said identifier of said node to an exception report for nodes that have migrated beyond a predetermined territory and may require special provisioning or forced unregistration.

10. The method of claim 7, further comprising determining if said node has migrated by:
initiating a communication from said host to said first communication device; and
retrieving said address of said second communication device from said first communication device.

11. The method of claim 7, further comprising providing a peer-to-peer communication link between said first communication device and said second communication device.

12. The method of claim 7, further comprising performing said coordination without intervention by said host.

13. A method of coordinating the migration of a metering node across a wireless metering reading network, comprising:
updating a mapping table in a second collector to include an identifier of said metering node after said metering node has migrated from a first collector to said second collector;
leaving a forwarding address of said second collector at said first collector;
updating said metering node with an address of said second collector; and
notifying a host system that said metering node has migrated.

14. The method of claim 13, further comprising:
determining if an identifier of said first collector is in said mapping table; and
if not, requesting said identifier of said first collector from said host.

15. The method of claim 13, further comprising adding said identifier of said metering node to an exception report for metering nodes that have migrated beyond an operating territory and may require special provisioning or forced unregistration.

16. The method of claim 13, further comprising determining said if metering node has migrated by:
initiating a communication from said host to said first collector; and
retrieving said address of said second collector from said first collector.

17. The method of claim 13, further comprising providing a peer-to-peer communication link between said first collector and said second collector.

18. The method of claim 13, further comprising using an address of said first collector to retrieve data and configuration information said metering node.

19. The method of claim 18, further comprising:
said second collector reading data associated with said metering node from said first collector; and
transferring said data to said second collector,
wherein said data includes at least one of the following: metered data, instrumentation data, status, events, alarms, demand reset armed status, billing ID, LP enabled flag, TOU ID and critical tier status.

20. The method of claim 13, further comprising using a broadcast message to determine that said metering node has migrated from said first collector to said second collector.
